(19) United States
(12) Patent Application Publication
(10) Pub. No.: US 2017/0269774 A1
(43) Pub. Date: Sep. 21, 2017

(54) VEHICLE CONTROL DEVICE AND MANUFACTURING METHOD

(71) Applicant: Faurecia Interieur Industrie, Nanterre (FR)

(72) Inventor: Omar BEN ABDELAZIZ, Beauvais (FR)

(21) Appl. No.: 15/460,012

(22) Filed: Mar. 15, 2017

(30) Foreign Application Priority Data
Mar. 15, 2016 (FR) 16 52190

(51) Int. Cl. G06F 3/041; B60K 37/06; B60Q 3/16; G06F 3/044; B60Q 3/14

(52) U.S. Cl. CPC G06F 3/0416; G06F 3/044; B60Q 3/14; B60Q 3/16; B60K 37/06; G06F 2203/04103

(57) ABSTRACT

A control device for a vehicle includes a transparent support, an opaque decorative layer, a detection layer, and a light source adapted for emitting a light passing through the transparent support. The opaque decorative layer is printed on the transparent support in a control area, and delimits a pattern forming a pictogram where the decorative layer is missing, with the pictogram having an outer edge. The detection layer is electrically conductive and printed on the transparent support around the pictogram, substantially up to the outer edge of the pictogram, in the control area.

### FIELD OF THE INVENTION

The invention relates to a control device, in particular for a vehicle, and a method for producing such control device.

### BACKGROUND OF THE INVENTION

Such control device is sometimes named control switch. More particularly, the invention relates to a so-called backlit control device, specifically in order to allow locating the control device in the dark and/or informing a user about the state of the appliance which the control device allows controlling.

Such device is usually arranged in the passenger compartment, in particular, on a dashboard, a central console, a door panel, or an overhead light.

### SUMMARY

An object of the invention is to provide a control device which may easily be produced, at an efficient cost, providing a good aesthetic quality while ensuring relying detection.

To this, in accordance with an aspect of the invention, the control device comprises:

a transparent support,

an opaque decorative layer, printed on the transparent support in a control area, the decorative layer delimiting a pattern forming a pictogram where the decorative layer is missing, said pictogram having an outer edge,

a detection layer, which is electrically conductive and printed on the transparent support around the pattern forming the pictogram in the control area, said detection layer having an inner edge, and

a light source adapted for emitting a light passing through the transparent support within the pattern forming the pictogram,

wherein the detection layer extends substantially up to the outer edge of the pictogram.

Thus, the decorative layer delimits the pictogram illuminated by the light source and masks the detection layer, while the detection layer allows good detection of the presence of a user finger facing the pictogram, extending substantially all around the pictogram.

The inner edge of the detection layer may have a noncircular shape that corresponds substantially to the shape of the outer edge of the pictogram.

Thus, detection layer forming a large diameter ring, very easy to produce but risking bad detection of the presence of a user finger when the user has a slim finger, is avoided.

The inner edge may be in the immediate proximity of the outer edge of the pictogram on at least the majority of the outer edge of the pictogram.

It should be understood by “immediate proximity” in particular being distant from 1 mm or less, and by “majority” more than half of the outer edge pictogram. Thus, detection quality is improved.

The inner edge of the detection layer may coincide with the outer edge of the pictogram on at least the majority of the outer edge of the pictogram.

Thus, detection is optimized in particular when allowed by the production method without risking showing the inner edge of the detection layer.

In various embodiments of the device, one and/or another of the following arrangements may potentially further be used:

the transparent support is formed by a film having a thickness of less than one millimeter, preferably less than 0.5 mm;

the support is made of polycarbonate (PC) or polyethylene terephthalate (PET);

the detection layer extends all around the pictogram;

the control device comprises a capacitive sensor, said capacitive sensor including said detection layer;

said detection layer is made of copper and/or silver;

the decorative layer is between the transparent support and the detection layer;

the control device further comprises a protective layer covering the detection layer and the decorative layer.

The invention also relates to a casing member comprising a rigid support molded on the control device.

The invention further relates to a method for producing a control device wherein the following steps are performed:

a) arranging a transparent support having a top surface and a bottom surface,

b) in the control area, printing with an opaque ink on the bottom surface of the transparent support to form an opaque decorative layer, the decorative layer delimiting a pattern forming a pictogram where the decorative layer is missing, said pictogram having an outer edge,

c) in the control area, printing with an electrically conductive ink on the transparent support substantially up to the outer edge of the pictogram,

d) arranging a light source in the control area, facing the bottom surface of the transparent support.

Thus, the production is relatively simple and inexpensive, while providing a good detection quality and a good appearance.

In various embodiments of the method according to the invention, one and/or another of the following arrangements may potentially further be used:

step c) is performed after step c) and during step c) the electrically conductive ink is printed on the opaque ink;

printing is performed at steps b) and c) by screen printing;

a mask is used for producing the pictogram at step b) and said mask is used at step c);

the method further comprises a step during which the transparent support is arranged in a molding cavity, and then the molding cavity is filled with plastic material in order to mold a rigid support on the bottom surface of the transparent support.

### BRIEF DESCRIPTION OF THE FIGURES

Other features and advantages of the present invention will appear in the following detailed description, referring to the accompanying drawings wherein:

FIG. 1 represents a control device in compliance with the invention,

FIG. 2 represents a control device viewed in section along the II-II line located in FIG. 1,

FIG. 3 represents a first step of a method in compliance with the invention for producing the control device,

FIG. 4 represents a second step of a method in compliance with the invention for producing the control device,

FIG. 5 represents a third step of a method in compliance with the invention for producing the control device,

FIG. 6 is a scaled up view of the area VI located in FIG. 5,

FIG. 7 represents a fourth step of the method in compliance with the invention for producing the control device.

FIG. 8 represents a fifth step of the method in compliance with the invention for producing the control device.

### DETAILED DESCRIPTION

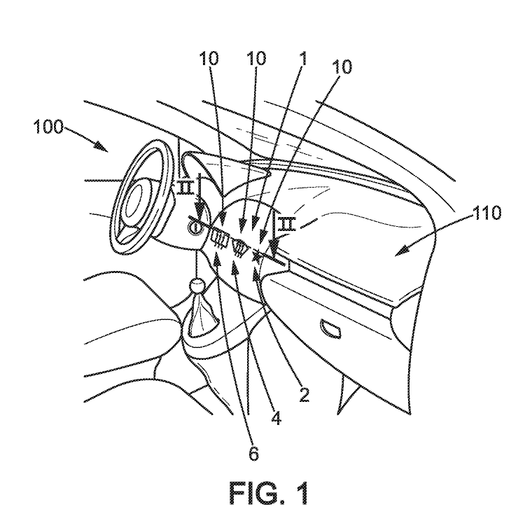

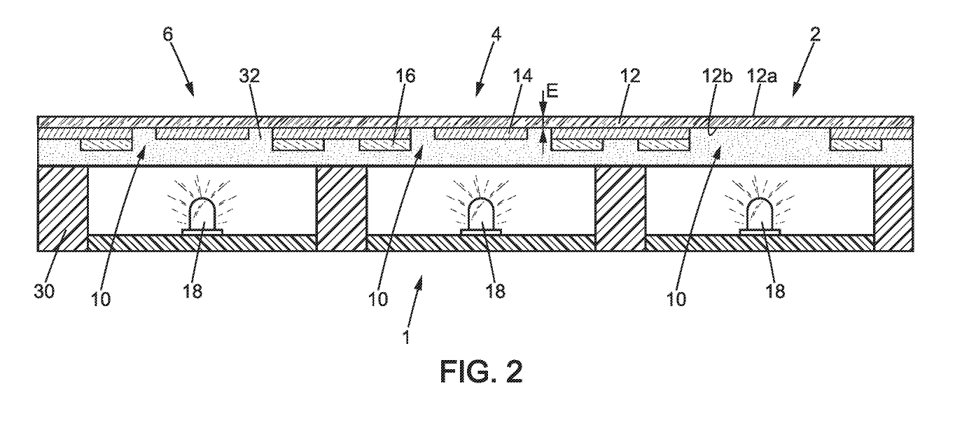

FIGS. 1 and 2 represents a casing member 110 arranged in the passenger compartment 100. In the represented embodiment, the casing member 110 constitutes a dashboard and more precisely a central console.

The casing member 110 comprises a rigid support of 30 molded on a control device 1. The control device 1 has three control areas 2, 4, 6 each comprising a pictogram 10 having an outer edge 10a.

The control device 1 comprises mainly a transparent support 12, a decorative support 14, a capacitive sensor 20 including a detection layer 16, as well as a light source 18 for lighting the pictogram of each of the control areas 2, 4, 6.

The transparent support 12 has a top surface 12a and a bottom surface 12b. In the represented embodiment, the transparent support 12 is flexible and formed by a film having a substantially constant thickness, preferably smaller than 1 mm, preferably substantially equal to 0.3 mm. The transparent support 12 is preferably made of polycarbonate (PC) or polyethylene terephthalate (PET).

The decorative layer 14 is opaque and electrically insulating. It has a substantially constant thickness and is arranged on the bottom surface 12b of the transparent support 12. Optionally, one or more translucent layers may be interposed between the transparent support 12 and the decorative layer 14, in order to improve the aesthetic appearance of the control device 1, having a top surface 12a of the support 12 constituting the visible portion.

The decorative layer 14 delimits a pattern forming a pictogram 10. That is, the lack of decorative layer 14 defines the pictogram 10. The outer edge 10a of each of the pictograms 10 therefore constitutes a rim of the decorative layer 14. In the represented embodiment, each of the pictograms 10 is entirely surrounded by the decorative layer 14, so that the pictograms 10 are apart from the periphery of the control device 1. It will be noted that based on the pattern of the pictogram 10, the decorative layer 14 may or not be present inside the area delimited by the outer edge 10a of the pictogram. Thus, in the control area 2, the decorative layer 14 is not present inside the area delimited by the inner edge 10a of the pictogram 10, while in the control areas 4, 6, the decorative layer 14 comprises a first portion located outside the inner edge 10a of the pictogram 10 and a second portion located inside the inner edge 10a of the pictogram 10, said first portion and second portion of the decorative layer 14 being separate.

The detection layer 16 is electrically current-conductive and entirely arranged on the decorative layer 14. The detection layer 16 extends forming a strip delimited by an inner edge 16a and an outer edge 16b and which is closed on itself around the pictogram 10 of each of the other control areas 2, 4, 6 in the represented embodiment. The decorative layer 14 is interposed between the detection layer 16 and the transparent support 12, so that the detection layer is not visible to a user on the top surface 12a side.

The inner edge 16a of the detection layer 16 may be slightly recessed relative to the outer edge 10a of the pictogram 10. However, advantageously and in the represented embodiment, the inner edge 16a of the detection layer 16 corresponds to the outer edge 10a of the pictogram 10 for each control area 2, 4, 6. Thus, the outer edge 10a of the pictogram 10 having a noncircular shape, the inner edge 16a of the detection layer 16 has the same shape. Nevertheless, the outer edge 16b of the detection layer 16 is preferably substantially circular.

The capacitive sensor 20 comprises the detection layer 16 in each of the detection areas 2, 4, 6, as well as an antenna 22 connecting each detection layer 16 to an electronic unit 28, via a flexible sheet 24 formed by a lug of the transparent support 12 and a connector 26.

A protective layer 32, which is optional and consisting of a varnish, is arranged on the side of the bottom surface 12b of the transparent support and covers the detection layer 16, the decorative layer 14, as well as the transparent support 12 at the pictogram 10.

Each of the light sources 18 is arranged facing the bottom surface 12b of the transparent support 12, at each of the control areas 2, 4, 6, in order to emit light through the transparent support 12 within the pictogram 10.

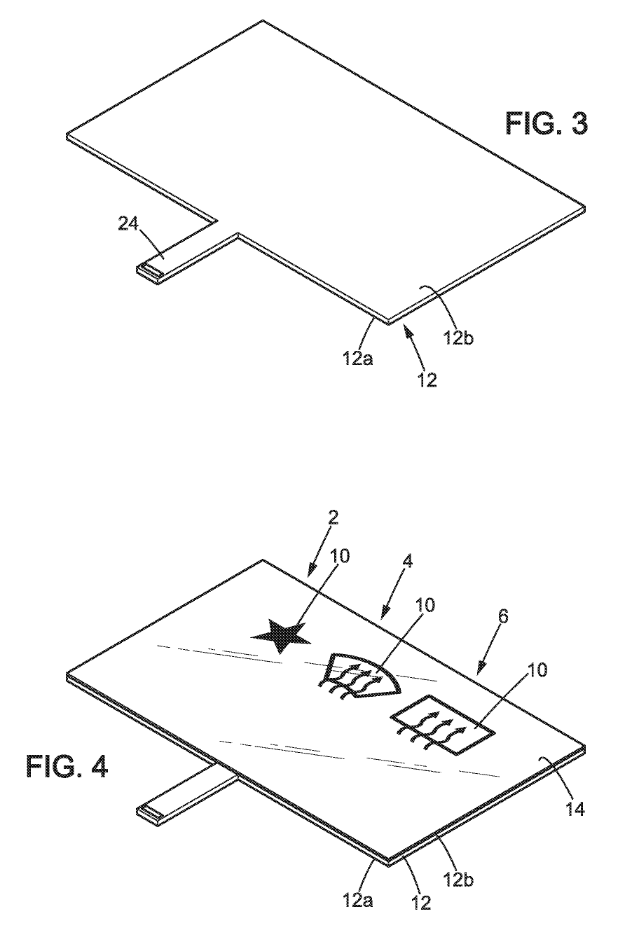

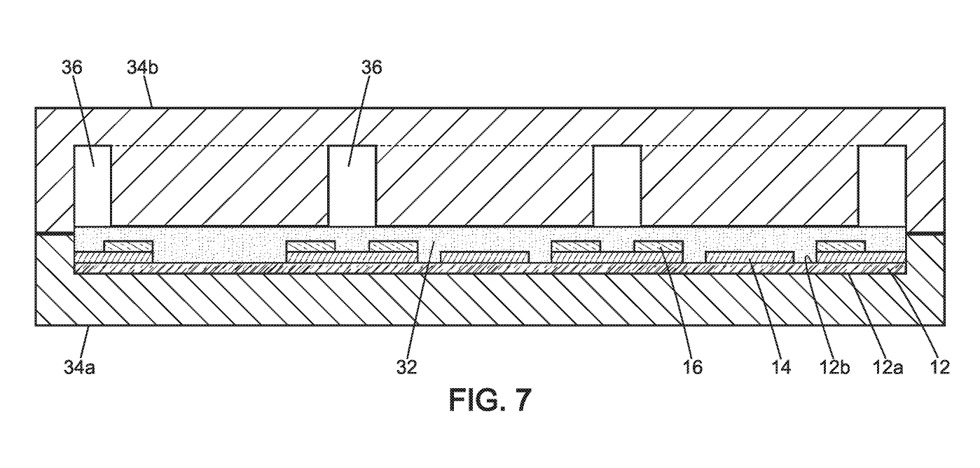

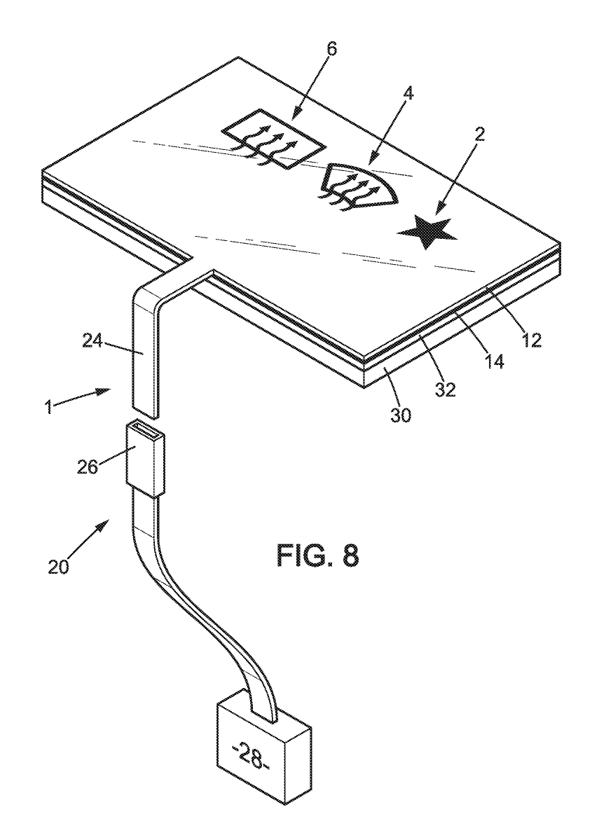

A method for producing the control device will now be described with respect to FIGS. 3 to 8.

As represented in FIG. 3, the transparent support 12 having the top surface 12a and the bottom surface 12b is prepared. In an optional manner, the lug 24 may be provided for a later connection of the detection layer to the electronic unit 30.

Then, as represented in FIG. 4, an opaque ink layer is deposited by printing on the bottom surface 12b of the transparent support, in order to form the decorative layer 14. Preferably, depositing the opaque ink layer is performed substantially on the whole bottom surface 12b, except for the pattern corresponding to the pictogram 10 of each detection area 2, 4, 6. Depositing ink is advantageously performed by screen printing. A mask corresponding to the pattern of the pictogram allows preventing the presence of opaque ink and consequently of the decorative layer 14 on the other side of the pictogram 10. The decorative layer 14 thus preferably has a substantially constant thickness in the order of 0.1 millimeters.

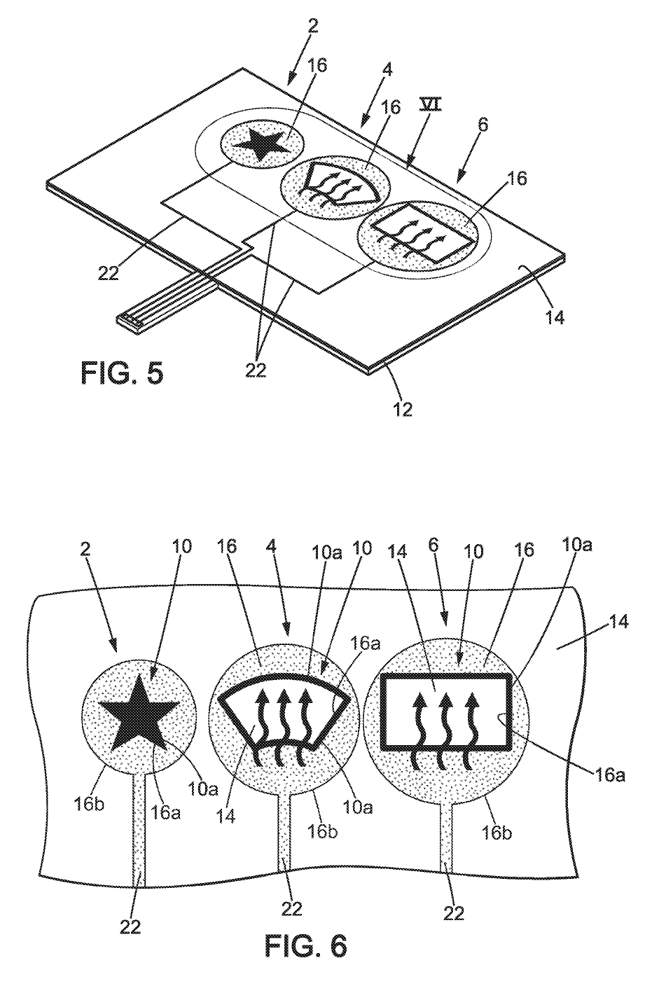

Then, as represented in FIG. 5, an electrically conductive ink is deposited by printing on the decorative layer 14 around the pictogram 10 of each of the control areas 2, 4, 6. The electrically conductive ink is advantageously deposited all around the pictogram 10, to form the detection layer 14 and also between the detection layer 16 of each of the control areas 2, 4, 6 and the lug 24 to form antennas 22. Preferably, the electrically conductive ink is deposited by screen printing and the same mask is used for preventing deposition of electrically conductive ink at the pictogram and ensuring that the inner edge 16a of the detection layer 16 corresponds closely to the outer edge 10a of the pictogram for each control area 2, 4, 6. The conductive ink is advantageously produced with a copper or silver base. The detection layer 16 thereby produced is electrically conductive and preferably has a substantially constant layer in the order of 0.1 millimeters.

Then, the protective layer 32 is applied against the entire bottom surface 12a of the transparent support 12.

Then, the detection device 1 formed by the transparent support 10 covered with the decorative layer 14, the detection layer 16, and optionally the protective layer 32 is arranged into a molding cavity 36 between a first portion 34a and a second portion 34b of a mold 34. Plastic material is introduced in to the molding cavity 36 to produce the rigid support 30, made of opaque plastic material, molded on the detection device 1.

Each light source 18 is then arranged facing the bottom surface 12a of the transparent support 10, so as to be able to selectively illuminate the pictogram of each control area 2, 4, 6.

It should be noted that the light emitted for each light source 18, is isolated from the pictogram of the adjacent detection layer, due to the opacity of the rigid support 30.

In the represented embodiment, the light sources 18 are carried by the rigid support 30. Alternatively, the light sources 18 may be carried by the transparent support 10.

1. A control device for a vehicle, comprising:
a transparent support,
an opaque decorative layer, printed on the transparent support in a control area, the decorative layer delimiting a pattern forming a pictogram where the decorative layer is missing, said pictogram having an outer edge,
a detection layer, electrically conductive and printed on the transparent support around the pictogram in the control area, said detection layer having an inner edge, and
a light source adapted for emitting a light passing through the transparent support, wherein the detection layer extends substantially up to the outer edge of the pictogram.

2. The control device according to claim 1 wherein said inner edge of the detection layer has a noncircular shape and corresponds substantially to the shape of the outer edge of the pictogram.

3. The control device according to claim 1 wherein said inner edge is in the immediate proximity of the outer edge of the pictogram on at least the majority of said outer edge of the pictogram.

4. The control device according to claim 3 wherein said inner edge of the detection layer coincides with the outer edge of the pictogram on at least the majority of said outer edge of the pictogram.

5. The control device according to claim 1 wherein the transparent support is formed by a film having a thickness of less than one millimeter, preferably less than 0.5 millimeters.

6. The control device according to claim 1 wherein the transparent support is formed by a film having a thickness of less than 0.5 millimeter.

7. The control device according to claim 1 wherein the detection layer extends all around the pictogram.

8. The control device according to claim 1 comprising a capacitive sensor, said capacitive sensor comprising said detection layer.

9. The control device according to claim 1 wherein the control device comprises a capacitive sensor, said capacitive sensor including said detection layer.

10. The control device according to claim 1 wherein said detection layer is made of copper and/or silver.

11. The control device according to claim 1 wherein the decorative layer is between the transparent support and the detection layer.

12. The control device according to claim 1 wherein the control device further comprises a protective layer covering the detection layer and the decorative layer.

13. A method for producing a control device, comprising the steps of:
a) arranging a transparent support having a top surface and a bottom surface,
b) in a control area, printing opaque ink on the bottom surface of the transparent support to form an opaque decorative layer, the decorative layer delimiting a pattern forming a pictogram where the decorative layer is missing, said pictogram having an outer edge,
c) in the control area, printing an electrically conductive ink on the transparent support substantially up to the outer edge of the pictogram,
d) arranging a light source in the control area, facing the bottom surface of the transparent support.

14. The method according to claim 13 wherein printing is produced at steps b) and c) by screen printing.

15. The method according to claim 13 further comprising a step e) during which the transparent support is placed in a molding cavity, and then the molding cavity is filled with a plastic material in order to mold a rigid support on the bottom surface of the transparent support.
